(19) United States
(12) Patent Application Publication
(10) Pub. No.: US 2023/0331956 A1
(43) Pub. Date: Oct. 19, 2023

(54) SULFIDE-CONTAINING STABILIZER SYSTEM FOR THIOL-ENE AND THIOL-YNE COMPOSITIONS

(71) Applicant: BRUNO BOCK CHEMISCHE FABRIK GMBH & CO. KG, Marschacht (DE)

(72) Inventors: Malte BUHMANN, Basedow (DE); Tom BEYERSDORFF, Deutsch Evern (DE); Frank EBMEYER, Lüneburg (DE); Matthias REHFELD, Reinbek (DE); Michael SCHMIDT, Norristown, PA (US)

(21) Appl. No.: 18/026,506

(22) PCT Filed: Aug. 26, 2021
(86) PCT No.: PCT/EP2021/073671

§ 371 Date: Mar. 15, 2023

(30) Foreign Application Priority Data
Sep. 15, 2020 (DE) 10 2020 124 036.8

(51) Int. Cl. C08K 5/13; C08K 5/372; C08K 5/09; C08K 5/3492; C08K 5/107

(52) U.S. Cl. CPC C08K 5/13; C08K 5/372; C08K 5/09; C08K 5/34924; C08K 5/107; C08K 2201/014

(57) ABSTRACT

The invention relates to a stabilizer system, in particular for thiol-ene and/or thiol-yne compositions, comprising: at least one free radical scavenger component, at least one acidic component, wherein the acidic component comprises one or more organic acids, and at least one sulfidic component selected from the group of organic sulfides. The stabilizer system according to the invention inhibits undesirable reactions in the thiol-ene composition or thiol-yne composition according to the invention during storage, so that longer storage is possible without influencing the quality. The stabilizer system according to the invention, however, does not mean that an intended reaction of the thiol with alkenes or alkynes in the respective thiol-ene and thiol-yne composition is no longer possible or is no longer possible at a sufficient speed.

The invention relates to a stabilizer system according to claim 1, the use of the stabilizer system according to claim 9 and a radiation-curable thiol-ene or thiol-yne composition according to claim 11.

The reaction of thiols with unsaturated organic compounds was first described in the literature in 1905 by Theodor Posner. To date, numerous comprehensive articles have been published on this subject. The photochemical reaction of thiols with unsaturated organic compounds is still of interest today, as it allows systems to be cured for a short period of time with low energy consumption.

EP 2 588 448 B1 describes the use of thiol-ene and thiol-yne compositions for producing films which contain light-emitting nanoparticles. EP 3 131 952 B1 describes the use of thiols together with alkynes for printable UV-crosslinkable resin systems. Further areas of application for radiation-curable thiol-ene and thiol-yne compositions are, for example, the production of gel nails, inks, coatings, adhesives and in the production of 3D objects by stereolithography or 3D printing.

In contrast to homopolymerization of acrylates or methacrylates, the thiol-ene and thiol-yne reactions are characterized by the fact that they are step-growth reactions and not chain-growth reactions. This results in more homogeneous networks and, associated therewith, less shrinkage and fewer inhomogeneities in the polymer. The degree of conversion of the monomers is higher in the case of thiol-ene and thiol-yne polymerizations. Another advantage is the insensitivity of the free radical polymerization process to oxygen.

The thioether-based polymer structures exhibit other interesting properties that are not accessible to the same extent by the photopolymerization of acrylates and methacrylates. For example, U.S. Pat. No. 8,440,736 B2 describes the special barrier properties of thiol-ene films.

Thiols can be added to unsaturated organic compounds such as alkenes or alkynes by a free radical reaction. This type of reaction is also referred to as a thiol-ene reaction in the case of alkenes and as a thiol-yne reaction in the case of the reaction with alkynes. Both reactions are summarized under the term thiol click reaction. The free radical polymerization can be initiated thermally or photochemically, in particular with the addition of one or more appropriate photoinitiators. Initiation only by light without the addition of a photoinitiator is also possible.

An alternative to the free radical addition of thiols to unsaturated organic compounds is the thiol-Michael addition, which proceeds in an ionic manner. The product is also a thioether as derived from the free radical mechanism. The thiol-Michael addition is catalyzed by bases or nucleophiles. Electrophilic unsaturated double bonds, such as those found in acrylates and methacrylates, favor the thiol-Michael addition.

A disadvantage of thiol-ene and thiol-yne compositions is that they are difficult to stabilize, particularly to achieve a long-term storage stability. All thiol-ene and thiol-yne reactions show spontaneous dark reactions, yielding polymers or at least oligomers in the absence of an initiator unless an effective stabilizer is added. These undesirable reactions during the storage of thiol-ene and thiol-yne compositions, which are stored in particular as premixed one-component systems, can lead to an increase in viscosity or to curing of the system.

WO 2011 155 239 A1 describes the use of substituted naphthalenes as stabilizers for thiol-ene compositions. WO 2012 126 695 A1 discloses the combination of phosphonic acid or acid phosphonate esters in combination with substituted benzene or naphthalene derivatives as a stabilizer system for thiol-ene compositions. A disadvantage of these stabilizers or stabilizer systems is that adequate stabilization of a thiol-ene composition for commercial storage cannot be achieved without preventing the desired reaction from occurring when the composition in question is applied. Although the thiol-ene compositions are then storage-stable, they cannot be sufficiently cured with the methods chosen. This hinders the commercial applicability of the stabilizer systems used.

The object of the invention is therefore to eliminate the disadvantages of the prior art and to provide a stabilizer system for a thiol-ene and/or thiol-yne composition which stabilizes it sufficiently and does not impede the application of the composition. The stabilizer system and a thiol-ene or thiol-yne composition with the stabilizer system should be simple and inexpensive to produce.

Main features of the invention are set out in claim 1. Embodiments are the subject of claims 2 through 12.

The object is achieved according to the invention by a stabilizer system, in particular for thiol-ene and/or thiol-yne compositions, comprising:
at least one free radical scavenger component (A)
at least one acidic component (B), wherein the acidic component (B) comprises one or more organic acids, and
at least one sulfidic component (C) selected from the group of organic sulfides

Insofar as individual substances, compounds or components are referred to below, it is of course to be assumed that there is a plurality of molecules.

A thiol-ene or thiol-yne composition comprises at least one thiol component (D), which comprises in particular a dithiol and/or polythiol, and a component having at least one unsaturated carbon compound (E). Unsaturated organic compounds that have at least one double bond between two bonded carbon atoms are called alkenes. Unsaturated organic compounds having at least one triple bond between two bonded carbon atoms are called alkynes. In particular, therefore, a thiol-ene composition comprises at least one thiol component and one alkene component. A thiol-yne composition comprises at least one thiol component and one alkyne component. In addition, a thiol-ene and thiol-yne composition can have other ingredients, such as a stabilizer system and/or one or more photoinitiators.

The stabilizer system according to the invention stabilizes a thiol-ene and/or thiol-yne composition so that premature reactions during storage are hindered or even prevented without the desired reaction being adversely affected upon application. The combination of the free radical scavenger component (A), the acidic component (B) in the form of an organic acid and the sulfidic component (C), which consists of an organic sulfide, brings about a synergy so that improved stabilization of a particularly photoreactive thiol-ene and/or thiol-yne composition can be achieved. In addition, desired reactions, in the form of curing through polymerization after the application of the thiol-ene, are not impeded.

The free radical scavenger component (A) preferably comprises one or more free radical scavengers selected from the following group: sterically hindered phenols, sterically hindered naphthalenes and sterically hindered amines.

Sterically hindered phenols as free radical scavengers are based on having at least one phenolic ring in their structure. They are characterized by one or more further substituents, such as hydroxyl, tert-butyl, or methyl groups, on at least one phenol ring. The group of sterically hindered phenolic free radical scavengers includes pyrogallol (1,2,3-trihydroxybenzene) and its esters, gallic acid and its esters, tocopherols, and tert-butylhydroxyquinone.

Sterically hindered naphthalenes as free radical scavengers are based on having a fused ring system in their structure. Just like the sterically hindered phenols, at least one benzene ring carries one or more other substituents, such as hydroxyl, tert-butyl, or methyl groups.

The free radical scavenger component (A) preferably comprises one or more of the following phenols: 1,3,5-tris(4-tert-butyl-3-hydroxy-2,6-dimethylbenzyl)-1,3,5-triazine-2,4,6-(1H,3H,5H)-trione, 2,2′-methylenebis(4-ethyl-6-tert-butylphenol), pentaerythritol tetrakis [3-(3,5-di-tert-butyl-4-hydroxyphenyl)propionate], tetrakis [methylene-3-(3,5-di-tert-butyl-4-hydroxyphenyl)propionate)] methane, 1,3,5-trimethyl-2,4,6-tris(3,5-di-tert-butyl-4-hydroxybenzyl)benzene, octadecyl 3-(3,5-di-tert-butyl-4-hydroxyphenyl)propionate, hexamethylene bis(3-(3,5-di-tert-butyl-4-hydroxyphenyl)propionate, 1,3,5-tris (3,5-di-tert-butyl-4-hydroxybenzyl)-1,3,5-triazine-2,4,6(1H,3H,5H)-trione, alpha-tocopherol, 2,6-di-tert-butyl-4-sec-butylphenol, 2,6-di-tert-butyl-4-nonylphenol, 2,5-di-tert-amylhydroquinone, 4,4′-butylidenebis(6-tert-butyl-m-cresol), 4,4′,4″-(1-methylpropanyl-3-ylidene)tris[6-tert-butyl-m-cresol], 2,2′-methylenebis[6-(1-methylcyclohexyl)-p-cresol], ethylenebis(oxyethylene)bis[3-(5-tert-butyl-4-hydroxy-m-tolyl)propionate], poly(dicyclopentadiene-co-p-cresol), 6-tert-butyl-2,4-xylenol, 2,2′-(2-methylpropylidene)bis[4,6-xylenol], 2,6-di-tert-butyl-4-methylphenol, pyrogallol (1,2,3-trihydroxybenzene), propyl gallate (propyl 3,4,5-trihydroxybenzoate), C7-9-alkyl 3-(3,5-di-tert-butyl-4-hydroxyphenyl)propionate (CAS 125643-61-0).

Most preferably, the free radical scavenger component (A) is 1,3,5-tris(4-tert-butyl-3-hydroxy-2,6-dimethylbenzyl)-1,3,5-triazine-2,4,6-(1H,3H,5H)-trione (CAS 40601-76-1), pyrogallol (1,2,3-trihydroxybenzene—CAS 87-66-1), propyl gallate (propyl 3,4,5-trihydroxybenzoate—CAS 121-79-9) or a combination thereof.

In a preferred embodiment, the one or more organic acids of the acidic component (B) have a pKₐ value in the range from 1 to 5.5 at 25° C. This is sufficient acid strength to achieve a synergistic effect in the stabilization of a thiol-ene or thiol-yne composition by the stabilizer system. In one embodiment, the organic acids have a pKₐ in the range of 3.5 to 5.5. Examples of suitable acids are acrylic acid (pKₐ 4.256), methacrylic acid (pKₐ 4.66), lactic acid (pKₐ 3.9), formic acid (pKₐ 3.8), acetic acid (pKₐ 4.75) and propionic acid (pKₐ 4.87). In a further embodiment, the organic acids preferably have a pKₐ value in the range from 1 to 3. Examples of suitable acids are organic acid esters of phosphoric acids, methacrylic acid esters of phosphoric acids or acidic acrylate and methacrylate derivatives.

The acidic component (B) preferably comprises one or more organic acids, in particular one or more unsaturated carboxylic acids or carboxylic acid derivatives, such as carboxylic acids having phosphonic acid groups. The acidic component (B) particularly preferably comprises one or more organic acids selected from the following group: Methacrylic acid, acrylic acid, and derivatives thereof and Ebecryl® 168, available from Allnex USA, Inc., which has an acid methacrylate, Miramer SC1400, a phosphoric acid ester of a methacrylic acid derivative, from Miwon Specialty Chemical. The acidic component (B) is particularly preferably methacrylic acid, acrylic acid, Ebecryl® 168, Miramer® SC1400 or a mixture thereof.

In a preferred embodiment, the one or more organic sulfides of the sulfidic component (C) has further functional units in the structure, in particular ester functions. These have proven to be particularly advantageous. In particular, the organic sulfides do not have any free thiols, acids and/or hydroxy functions.

One or more organic sulfides selected from the following group are preferably used as the sulfidic component (C): Ditridecyl thiodipropionate, dilauryl thiodipropionate, distearyl thiodipropionate, dimethyl thiodipropionate, octadecyl3-[[3-(dodecyloxy)-3-oxopropyl]thio]propionate, dimyristyl thiodipropionate, 2,2-bis{[3-(dodecylthio)-1-oxopropoxy]methyl}propane-1,3-diylbis[3-(dodecylthio)propionate]. The sulfidic component (C) is particularly preferably ditridecyl thiodipropionate, dilauryl thiodipropionate or a combination thereof.

In a further development, the at least one free radical scavenger component (A) and the at least one sulfidic component (C) comprise the same substance, in particular selected from the group:
thiodiethylene bis[3-[3,5-di-tert-butyl-4-hydroxyphenyl]propionate], 2,2′-thiobis(6-tert-butyl-p-cresol), 4,4′-thiobis(2-t-butyl-5-methylphenol), 4,6-bis(octylthiomethyl)-o-cresol.

In a preferred embodiment, the stabilizer system contains the free radical component (A), the acidic component (B) and the sulfidic component (C) in each case at 10 to 80 wt %, based on the total weight of the stabilizer system.

The stabilizer system according to the invention preferably comprises
to 80 wt %, particularly preferably 20 to 80 wt %, of free radical scavenger component (A),
to 80 wt %, particularly preferably 10 to 50 wt %, of acidic component (B) and
to 80 wt %, particularly preferably 10 to 50 wt %, of sulfidic component (C),
   wherein the components add up to 100 wt %.

The stabilizer system according to the invention preferably comprises
as free radical scavenger component (A) one or more of the following phenols: 1,3,5-tris(4-tert-butyl-3-hydroxy-2,6-dimethylbenzyl)-1,3,5-triazine-2,4,6-(1H,3H,5H)-trione, 2,2′-methylenebis(4-ethyl-6-tert-butylphenol), pentaerythritol tetrakis [3-(3,5-di-tert-butyl-4-hydroxyphenyl)propionate], tetrakis [methylene-3-(3,5-di-tert-butyl-4-hydroxyphenyl-propionate)] methane, 1,3,5-trimethyl-2,4,6-tris(3,5-di-tert-butyl-4-hydroxybenzyl)benzene, octadecyl 3-(3,5-di-tert-butyl-4-hydroxyphenyl)propionate, hexamethylene bis(3-(3,5-di-tert-butyl-4-hydroxyphenyl)propionate, 1,3,5-tris (3,5-di-tert-butyl-4-hydroxybenzyl)-1,3,5-triazine-2,4,6(1H,3H,5H)-trione, alpha-tocopherol, 2,6-di-tert-butyl-4-sec-butylphenol, 2,6-di-tert-butyl-4-nonylphenol, 2,5-di-tert-amylhydroquinone, 4,4′-butylidenebis(6-tert-butyl-m cresol), 4,4′,4″-(1-methylpropanyl-3-ylidene)tris[6-tert-butyl-m-cresol], 2,2′-methylenebis[6-(1-methylcyclohexyl)-p-cresol], ethylenebis(oxyethylene)bis[3-(5-tert-butyl-4-hydroxy-m-tolyl)propionate], poly(dicyclopentadiene-co-p-cresol), 6-tert-butyl-2,4-xylenol, 2,2′-(2-methylpropylidene)bis[4,6-xylenol], 2,6-di-tert-butyl-4-methylphenol, pyrogallol (1,2,3-trihydroxybenzene), propyl gallate (propyl 3,4,5-trihydroxybenzoate), C7-9-alkyl 3-(3,5-di-tert-butyl-4-hydroxyphenyl)propionate and
as acidic component (B) one or more organic acids selected from the following group: methacrylic acid, acrylic acid and derivatives thereof, Ebecryl® 168 and Miramer® SC1400 and
as sulfidic component (C) one or more organic sulfides selected from the group consisting of ditridecyl thiodipropionate, dilauryl thiodipropionate, distearyl thiodipropionate, dimethyl thiodipropionate, octadecyl 3-[[3-(dodecyloxy)-3-oxopropyl]thio]propionate, dimyristyl thiodipropionate, 2,2-bis{[3-(dodecylthio)-1-oxopropoxy]methyl}propane-1,3-diylbis[3-(dodecylthio)propionate], dimercaptodiethylsulfide dimethacrylate, 2,3-di((2-mercaptoethyl)thio)-1-propanethiol diacrylate, 2,2′-thioethanedithiol diacrylate and mixtures thereof.

The stabilizer system according to the invention particularly preferably comprises
as free radical scavenger component (A) 1,3,5-tris(4-tert-butyl-3-hydroxy-2,6-dimethylbenzyl)-1,3,5-triazine-2,4,6-(1H,3H,5H)-trione, pyrogallol, propyl gallate or a combination thereof,
as acidic component (B) methacrylic acid, acrylic acid, Ebecryl® 168, Miramer® SC1400 or a mixture thereof and
as sulfidic component (C) ditridecyl thiodipropionate, dilauryl thiodipropionate or a combination thereof.

The stabilizer system is used in radiation-curable or thermally-curable thiol-ene and/or thiol-yne compositions, particularly preferably in a thiol-ene composition. The stabilizer system according to the invention is preferably used in a radiation-curable or thermally curable thiol-ene or thiol-yne composition in an amount of 0.05 to 1.5 wt %, particularly preferably 0.1 to 0.5 wt % based on the polythiol used.

In addition, the invention relates to a radiation-curable thiol-ene or thiol-yne composition comprising at least one stabilizer system according to the invention, at least one thiol component (D), a component having at least one unsaturated carbon compound (E) and a photoinitiator (F).

The thiol component (D) preferably has one thiol or several thiols each having two or more free thiol functions.

A thiol having two free thiol functions is called a dithiol. In addition, thiols having two or more thiol functions are referred to as polythiols or polymercaptans. Commercially readily available, for example from Bruno Bock Chemische Fabrik GmbH&Co. and Evans Chemetics LP, are esters of various mercaptocarboxylic acids and polyfunctional alcohols. In the case of the mercaptocarboxylic acids, thioglycolic acid, 2-mercaptopropionic acid, 3-mercaptopropionic acid and also 3-mercaptobutyric acid are used in particular but not exclusively. For the esterification partners, the polyfunctional alcohols, ethylene glycol, trimethylolpropane, ditrimethylolpropane, pentaerythritol, dipentaerythritol and tris(2-hydroxyethyl)-1,3,5-triazinetrione and polymeric polyols, for example based on the ethoxylated versions of the aforementioned polyols, are used.

In addition to ester-based polythiols, other ester-free polythiols can also be used. Examples of this are dimercaptodiethyl sulfide, 2,3-bis((2-mercaptoethyl)thio)-1-propanethiol, 1,8-dimercapto-3,6-dioxaoctane (CAS 14970-87-7), but also polysulfides. Other polythiols free of ester bonds result, for example, from the reaction of primary and secondary amines with esters of mercaptocarboxylic acids and from the reaction of epoxides with hydrogen sulfide.

The thiol component (D) preferably comprises one or more thiols selected from the following group: glycol dimercaptoacetate (CAS 123-81-9), trimethylolpropane tris(2-mercaptoacetate) (CAS 10193-96-1-1,1,1), pentaerythritol tetramercaptoacetate (CAS 10193-99-4), glycol di(3-mercaptopropionate) (CAS 22504-50-3), trimethylolpropane tri(3-mercaptopropionate) (CAS 33007-83-9), tris[2-(3-mercaptopropionyloxy)ethyl]isocyanurate (CAS 36196-44-8), ethoxylated trimethylpropane tri(3-mercaptopropionate) with an average molar mass of 700 or 1300 g/mol (CAS 674786-83-5 or 345352-19-4), pentaerythritol tetra(3-mercaptopropionate) (CAS 7575-23-7), polycaprolactone tetra(3-mercaptopropionate) with an average molar mass of 1350 g/mol (CAS 1622079-69-9), dipentaerythritol hexakis(3-mercaptopropionate) (CAS 25359-71-1), pentaerythritol tetrakis(3-mercaptobutylate) (CAS 31775-89-0), polypropylene glycol (3-mercaptopropionate) with an average molar mass of 800 or 2200 g/mol, all of which are available from Bruno Bock Chemische Fabrik and Evans Chemetics under the brand name Thiocure® with the corresponding identifier. The group also includes:

Capcure® 3-800 from the manufacturer Gabriel (CAS 72244-98-5), GABEPRO GPM 800 from the manufacturer Gabriel, POLYTHIOL™ QE-340M from the manufacturer Toray, trimercaptotriazine (CAS 638-16-4) from the manufacturer EVONIK, and the thiols sold by Bruno Bock under the names Thiocure 1200, Thiocure 1200V (Thiocure 1200=poly[oxy(methyl-1,2-ethanediyl)], alpha.-hydro-.omega.-hydroxy-, ether with 2,2-bis(hydroxymethyl)-1,3-propanediol (4:1), 2-hydroxy-3-mercaptopropyl ether (CAS 72244-98-5; Thiocure1200V=poly[oxy(methyl-1,2-ethanediyl)], alpha.-hydro-.omega.-hydroxy-, ether with 2,2-bis(hydroxymethyl)-1,3-propanediol (4:1), 2-hydroxy-3-mercaptopropyl ether (CAS 72244-98-5).

The thiol component (D) is preferably selected from the group consisting of pentaerythritol tetramercaptoacetate, glycol di(3-mercaptopropionate), trimethylolpropane tri(3-mercaptopropionate), tris[2-(3-mercaptopropionyloxy)ethyl]isocyanurate, pentaerythritol tetra(3-mercaptopropionate), di-pentaerythritol hexakis(3-mercaptopropionate), pentaerythritol tetrakis(3-mercaptobutylate), or mixtures thereof. These thiols are available, for example, under the brand names Thiocure® and Evabotec® from Bruno Bock Chemische Fabrik GmbH & Co. KG or Evans Chemetics LP

The polyfunctionally unsaturated organic compounds include compounds having at least one carbon double bond, what are termed alkenes, and/or having at least one triple bond—what are termed alkynes. These compounds can be pure hydrocarbons and compounds that also contain heteroatoms. In particular, alkenes in the form of acrylates, methacrylates, allyl ethers and vinyl ethers are commercially readily available and used in many applications.

The unsaturated carbon compound (E) preferably comprises such a polyfunctionally unsaturated organic compound, in particular one or more acrylates, methacrylates, urethane acrylates, polyester acrylates, allyl ethers or vinyl ethers, particularly preferably an acrylate or methacrylate.

Acrylates are particularly preferred, for example trimethylolpropane triacrylate (TMPTA) (CAS 15625-89-5), butanediol diacrylate (BDDA) (CAS 1070-70-8), hexanediol diacrylate (HDDA) (CAS 13048-33-4), tripropylene glycol diacrylate (TPGDA) (CAS 42978-66-5), dipropylene glycol diacrylate (DPGDA) (CAS 57472-68-1), ethyl diglycol acrylate (EDGA) (CAS 7328-17-8), methacrylates, e.g., trimethylolpropane trimethacrylate (e.g., Miwon MIRAMER® M3000 from the manufacturer Miwon), triallyl isocyanurate, which is available for example under the TAICROS® brand (CAS 1025-15-6), triallyl cyanurate (TAC) (CAS 101-37-1), vinyl ethers, for example triethylene glycol divinyl ether (DVE), (CAS 765-12-8), 1,4-butanediol divinyl ether (CAS 3891-33-6), diethylene glycol divinyl ether (CAS 764-99-8) or 1,4-cyclohexane dimethanol divinyl ether (CAS 17351-75-6) or ally ethers such as allyl pentaerythritol (CAS 91648-24-7), or trimethylolpropane diallyl ether (CAS 682-09-7).

Other suitable unsaturated carbon compounds (E) are diallyl pyrocarbonate, diallyl diglycol carbonate, diallyl (2,2,4-trimethylhexane-1,6-diyl) dicarbamate, allyl acetate, allyl benzyl ether, allyl butyl ether; allyl cyanoacetate; allyl ether; allyl ethyl ether; allyl methyl carbonate; 2-allyloxybenzaldehyde; 2-allyloxyethanol; 4-allyloxy-2-hydroxybenzophenone; 3-allyloxy-1,2-propanediol; allyl phenyl ether; allylphosphonic acid monoammonium salt; 2,2′-diallylbisphenol; 2,2′-diallyl bisphenol A diacetate ether; diallyl carbonate; diallyl maleate; diethyl allyl malonate; 5-methyl-5-allyloxycarbonyl-1,3-dioxan-2-one; pentaerythritol allyl ether; 2,4,6-triallyloxy-1,3,5-triazine; 1,3,5-triallyl-1,3,5-triazine-2,4,6(1H,3H,5H)-trione; trimethylolpropane allyl ether; trimethylolpropane diallyl ether; 1,4-butanediol divinyl ether; 1,4-butanediol vinyl ether; butyl vinyl ether; tert-butyl vinyl ether; 2-chloroethyl vinyl ether; 1,4-cyclohexane dimethanol divinyl ether;

1,4-cyclohexanedimethanol vinyl ether; cyclohexyl vinyl ether; di(ethylene glycol) divinyl ether; di(ethylene glycol) vinyl ether; diethyl vinyl orthoformate; dodecyl vinyl ether; ethylene glycol vinyl ether; 2-ethylhexyl vinyl ether; ethyl vinyl ether; isobutyl vinyl ether; phenyl vinyl ether; propyl vinyl ether; vinyl acetate; vinyl benzoate; vinyl cinnamate; vinyl decanoate; vinyl neodecanoate; vinyl neononanoate; vinyl pivalate; vinyl propionate; vinyl stearate; hexanediol divinyl ester; hexanediol divinyl carbonate; butanediol divinyl carbonate; N-vinylpyrrolidone; N-vinyl caprolactam; N-vinylimidazole;

N-vinyl-N-methylacetamide; 1,4-butanediol divinyl ether; diethylene glycol divinyl ether; triethylene glycol divinyl ether; 1,4-cyclohexane dimethanol divinyl ether; hydroxybutyl vinyl ether; 1,4-cyclohexanedimethanol monovinyl ether; 1,2,4-trivinylcyclohexane; diallyl(2,2,4-trimethylhexane-1,6-diyl)dicarbamate.

In one embodiment, the unsaturated carbon compound (E) is selected from compounds having at least one carbon-carbon double bond in a (meth)acrylic group, such as 1,4-butanediol diacrylate; 1,4-butanediol dimethacrylate; isobutyl methacrylate; 1,3-butylene glycol diacrylate; ditrimethylolpropane tetraacrylate; hexanediol diacrylate; ethoxy-(3)cyclohexanol dimethanol diacrylate; 2-(2-ethoxyethoxy)ethyl acrylate; dipentaerythritol pentaacrylate; tripropylene glycol diacrylate; ethoxy-(3)cyclohexanol dimethanol diacrylate; 2-phenoxyethyl acrylate; propoxylated (3)trimethylolpropane triacrylate; dipropylene glycol diacrylate; propoxylated (3)cyclohexanol dimethanol diacrylate; cyclic trimethylolpropane formal acrylate; ethoxylated (5)pentaerythritol tetraacrylate; ethoxy (3)hexanediol diacrylate; ethoxy (3)phenoxyethyl acrylate; ethoxy (6)trimethylolpropane triacrylate; ethoxy(5)hexanediol diacrylate; propoxylated (6)trimethylolpropane triacrylate; propoxylated (3)hexanediol diacrylate; propoxylated (3)glyceryl triacrylate; propoxylated (2) neopentyl glycol diacrylate; 2(2-ethoxyethoxy)ethyl acrylate; isodecyl acrylate; octyl/decyl acrylate; lauryl acrylate; tridecyl acrylate; caprolactone acrylate; diethylene glycol butyl ether acrylate; isobornyl acrylate; tetrahydrofurfuryl acrylate; cyclic trimethylolpropane formal acrylate; isophoryl acrylate; 2-phenoxyethyl acrylate; ethoxylated (4) phenol acrylate; ethoxylated (4)nonylphenol acrylate; hexanediol diacrylate; tricyclodecanedimethanol diacrylate; dioxane glycol diacrylate; dipropylene glycol diacrylate; tripropylene glycol diacrylate; polyethylene glycol (200)diacrylate; ethoxylated bisphenol A diacrylate; propoxylated (2)neopentyl glycol diacrylate; trimethylolpropane triacrylate; propoxylated (3)trimethylolpropane triacrylate; ethoxylated (3)trimethylolpropane triacrylate; propoxylated glycerol triacrylate; tris(2-hydroxylethyl)isocyanurate triacrylate; dipentaerythritol penta/hexaacrylate; alkoxylated pentaerythritol tetraacrylate; di(trimethylol)propane tetraacrylate; epoxy acrylate; urethane acrylate; polyester acrylate; 4-acetoxyphenethyl acrylate; 4-acryloylmorpholine; (4-benzoyl-3-hydroxyphenoxy)ethyl acrylate; benzyl 2-propyl acrylate; butyl acrylate; tert-butyl acrylate; 2-carboxyethyl acrylate; 2-carboxyethyl acrylate; 2-chloroethyl acrylate; 2-(diethylamino)ethyl acrylate; di(ethylene glycol) ethyl ether acrylate; 2-(dimethylamino)ethyl acrylate; 3-(dimethylamino)propyl acrylate; dipentaerythritol penta/hexaacrylate; ethyl acrylate; ethyl 2-(bromomethyl)acrylate; ethyl cis(β-cyano)acrylate; ethylene glycol dicyclopentenyl ether acrylate; ethylene glycol methyl ether acrylate; ethylene glycol phenyl ether acrylate; ethyl 2-ethyl acrylate; 2-ethylhexyl acrylate; ethyl 2-propyl acrylate; ethyl 2-(trimethylsilylmethyl)acrylate; hexyl acrylate; 4-hydroxybutyl acrylate; 2-hydroxyethyl acrylate; 2-hydroxy-3-phenoxypropyl acrylate; hydroxypropyl acrylate; isobornyl acrylate; isobutyl acrylate; isodecyl acrylate; isooctyl acrylate; lauryl acrylate; methyl 2-acetamidoacrylate; methyl acrylate; methyl 2-(bromomethyl)acrylate; methyl 2-(chloromethyl)acrylate; methyl 3-hydroxy-2-methylenebutyrate; methyl 2-(trifluoromethyl)acrylate; octadecyl acrylate; pentabromobenzyl acrylate; pentabromophenyl acrylate; pentafluorophenyl acrylate; poly(ethylene glycol) diacrylate; poly(ethylene glycol) methyl ether acrylate; N-propylacrylamide; epoxidized soybean oil acrylate; tetrahydrofurfuryl acrylate; 2-tetrahydropyranyl acrylate; 3-(trimethoxysilyl)propyl acrylate; 3,5,5-trimethylhexyl acrylate; 10-undecenyl acrylate; urethane acrylate methacrylate; allyl methacrylate; 2-[3-(2H-benzotriazol-2-yl)-4-hydroxyphenyl]ethyl methacrylate; benzyl methacrylate; bis(2-methacryloyl)oxyethyl disulfide; butyl methacrylate, tert-butyl methacrylate, 9H-carbazole-9-ethyl methacrylate; cyclohexyl methacrylate; 1,10-decamethylene glycol dimethacrylate; 2-5 (diethylamino)ethyl methacrylate; diethylene glycol butyl ether methacrylate; di(ethylene glycol) methyl ether methacrylate; 2-(diisopropylamino)ethyl methacrylate; 2-(dimethylamino)ethyl methacrylate; 2-ethoxyethyl methacrylate; ethylene glycol dimethacrylate; ethylene glycol dicyclopentenyl ether methacrylate; ethylene glycol methyl ether methacrylate; ethylene glycol phenyl ether methacrylate; 2-ethylhexyl methacrylate; ethyl methacrylate; furfuryl methacrylate; glycidyl methacrylate; glycosyloxyethyl methacrylate; hexyl methacrylate; hydroxybutyl methacrylate, 2-hydroxyethyl methacrylate; 2-hydroxyethyl methacrylate; hydroxypropyl methacrylate; 2-hydroxypropyl-2-(methacryloyloxy)ethyl phthalate; 2-hydroxy-3-{3-[2,4,6,8-tetramethyl-4,6,8-tris(propylglycidyl ether)-2-cyclotetrasiloxanyl]propoxy}propyl methacrylate; isobornyl methacrylate; isobutyl methacrylate; 2-isocyanatoethyl methacrylate; isodecyl methacrylate; lauryl methacrylate; methyl methacrylate; 2-(methylthio)ethyl methacrylate; mono-2-(methacryloyloxy)ethyl maleate; mono-2-(methacryloyloxy)ethyl succinate; 2-N-morpholinoethyl methacrylate; 1-naphthyl methacrylate; 1,4-phenylene dimethacrylate, phenyl methacrylate; phosphoric acid 2-hydroxyethyl methacrylate ester; 1-pyrenemethyl methacrylate; pyromellitic dianhydrate dimethacrylate; tetraethylene glycol dimethacrylate; tetrahydrofurfuryl methacrylate; triethylene glycol dimethacrylate; triethylene glycol methyl ether methacrylate; 3,3,5-trimethylcyclohexyl methacrylate, urethane acrylate methacrylate; urethane epoxy methacrylate; vinyl methacrylate; and urethane dimethacrylate.

In one embodiment, the unsaturated compound (E) is a compound having at least one carbon triple bond, what is termed an alkyne. Suitable alkyne compounds are, for example, unsaturated compounds (E) having at least one terminal functional alkyne group or several terminal functional alkyne groups. The following alkynes can be used, for example:

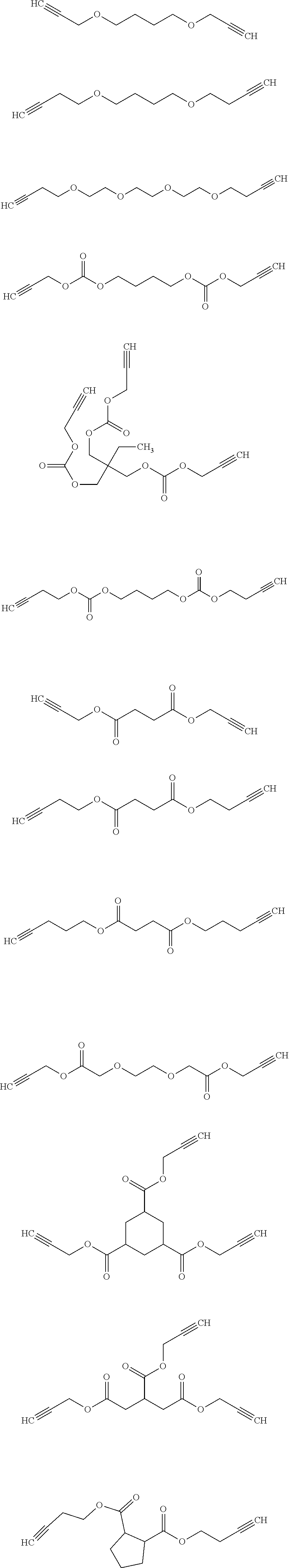

other suitable compounds are di(but-3-yn-1-yl)carbonate, di(prop-2-yn-1-yl)carbonate and di(but-3-yn-1-yl)(2,2,4-trimethylhexane-1,6-diyl)dicarbamate.

Preferably, the unsaturated compound (E) is selected from the group consisting of an acrylate selected from TMPTA (trimethylolpropane triacrylate), PETTA (pentaerythritol tetraacrylate), DPHA (dipentaerythritol hexaacrylate), a methacrylate selected from EGDMA—ethylene glycol dimethacrylate and TMPTMA—trimethylolpropane trimethacrylate or triallyl isocyanurate, allyl pentaerythritol or trimethylolpropane diallyl ether, or a combination of said monomers.

The photoinitiator (F) is preferably selected from the group consisting of: 2-hydroxy-2-methyl-1-phenylpropan-1-one (CAS 7473-98-5), bis(2,4,6-trimethylbenzoyl)phenylphosphine oxide (CAS 162881-26-7), phenyl bis(2,4,6-trimethylbenzoyl)phosphine oxide 2,2-dimethoxy-1,2-diphenylethan-1-one, 2,4,6-trimethylbenzoyldiphenylphosphine oxide (CAS 75980-60-8), 2,4,6-trimethylbenzoylethoxyphenylphosphine oxide (CAS 84434-11-7), and mixtures thereof.

The thiol-ene composition according to the invention preferably contains at least one thiol component (D) selected from the group consisting of pentaerythritol tetramercaptoacetate, tris[2-(3-mercaptopropionyloxy)ethyl]isocyanurate and pentaerythritol tetra(3-mercaptopropionate), or mixtures thereof, and a component containing at least one unsaturated carbon compound (E) selected from the group consisting of trimethylolpropane triacrylate, pentaerythritol tetraacrylate, dipentaerythritol hexaacrylate, ethylene glycol dimethacrylate, trimethylolpropane trimethacrylate triallyl isocyanurate, allyl pentaerythritol, and trimethylolpropane diallyl ether.

The radiation-curable thiol-ene or thiol-yne composition according to the invention contains as the stabilizer system preferably as the free radical scavenger component (A) 1,3,5-tris(4-tert-butyl-3-hydroxy-2,6-dimethylbenzyl)-1,3,5-triazine-2,4,6-(1H,3H,5H)-trione, pyrogallol, propyl gallate or a combination thereof, as acidic component (B) methacrylic acid, acrylic acid, Ebecryl® 168, or a mixture thereof and as sulfidic component (C) ditridecyl thiodipropionate, dilauryl thiodipropionate, dimethyl thiodipropionate, or a combination thereof.

In a preferred embodiment, the radiation-curable thiol-ene or thiol-yne composition has the stabilizer system according to the invention at 0.05 to 1.5 wt %, more preferably 0.1 to 0.5 wt %, particularly preferably 0.1 to 0.25 wt % based on the polythiol.

The stabilizer system according to the invention inhibits undesirable reactions in the thiol-ene composition or thiol-yne composition according to the invention during storage, so that longer storage is possible without influencing the quality. An increase in viscosity which indicates an undesired onset of the reaction does not occur, and the doubling of the viscosity which is an indication thereof can be effectively prevented. Gelling of the sample is prevented. The stabilizer system according to the invention, however, does not mean that an intended reaction of the thiol with alkenes or alkynes in the respective thiol-ene and thiol-yne composition is no longer possible or is no longer possible at a sufficient speed. A thiol-ene or thiol-yne composition mixed with the stabilizer system according to the invention shows sufficient reactivity despite the stabilizer system and can be cured normally.

Further features, details, and advantages of the invention result from the wording of the claims and from the following description of exemplary embodiments.

### Description of the Methods:

### Preparation of the Samples:

With the exception of the photoinitiator and the unsaturated compound, the individual components were mixed in after weighing on an analytical balance by stirring on a laboratory magnetic stirrer. The stirring time was 30 to 120 minutes. To aid solubility, it was sometimes necessary to increase the temperature of the mixture to up to 50° C.

The unsaturated component and the photoinitiator were first mixed in separately. The mixing process was carried out on a planetary centrifugal mixer (type: Thinky ARE-250). The stirring time was 90 seconds at a speed of 2,000 revolutions per minute.

Both mixtures were likewise mixed in a planetary centrifugal mixer for 90 seconds at a speed of 2000 rpm and then degassed for 30 seconds at 2200 rpm.

### Determination of the Viscosity:

A Haake Viscotester iQ from Thermo Fisher was used to determine the viscosity. A combination consisting of the rotor C352°/Ti under plate TMP35 was used. The measurement was carried out at a temperature of 20° C. The measured values are given in mPas.

### Storage of Samples:

The samples were stored at room temperature and at 60° C. in a circulating air-drying cabinet.

As soon as the viscosity of a thiol-ene or thiol-yne composition doubles, this was evaluated as the composition being unusable for the application. In view thereof, the measurements of the viscosity of the respective sample were usually stopped as soon as the viscosity doubled.

The invention will be explained in more detail using the following examples:

Thiol-ene compositions were prepared using the formulations given in Table 1 and Table 2:

TABLE 1
Formulations of the thiol-ene compositions according
to comparative examples V1, V2, V3 and V4

| | V1 | V2 | V3 | V4 |
|---|---|---|---|---|
| Triallylisocyanurate (TAICROS ®) | 39.7 g | 39.7 g | 39.7 g | 39.7 g |
| Pentaerythritol tetra(3- | 60.3 g | 60.3 g | 60.3 g | 60.3 g |
| mercaptopropionate) | | | | |
| 2,4,6- | 0.5 g | 0.5 g | 0.5 g | 0.5 g |
| Trimethylbenzoylethoxyphenylphosphine | | | | |
| oxide | | | | |
| Pyrogallol | — | 0.05 g | — | — |
| Ditridecyl thiodipropionate | — | — | 0.1 g | — |
| Ebercryl ® 168 | — | — | — | 0.1 g |

Abbreviations:
Free radical scavenger component (A)
Acidic component (B)
Sulfidic component (C)
V1: without stabilizer system, i.e., without components (A), (B) and (C)
C2: with pyrogallol as the free radical scavenger component (A), components (B) and (C) not added
C3: with ditridecyl thiodipropionate as sulfide component (C), components (A) and (B) not added
V4: with Ebercryl ® 168 (acidic methacrylate) as acidic component (B), components (A) and (C) not added

TABLE 2
Formulations of thiol-ene compositions according
to the invention according to Examples 1, 2, 3

| | 1 | 2 | 3 |
|---|---|---|---|
| Triallylisocyanurate (TAICROS ®) | 39.7 g | 39.7 g | 39.7 g |
| Pentaerythritol tetra(3- | 60.3 g | 60.3 g | 60.3 g |
| mercaptopropionate) | | | |
| 2,4,6- | 0.5 g | 0.5 g | 0.5 g |
| trimethylbenzoylethoxyphenylphosphine | | | |
| oxide | | | |
| pyrogallol | 0.05 g | 0.05 g | 0.05 g |
| ditridecyl thiodipropionate | 0.05 g | 0.05 g | 0.05 g |
| Ebercryl ® 168 | 0.05 g | — | — |
| acrylic acid | — | 0.05 g | — |
| methacrylic acid. | — | — | 0.05 g |

The thiol-ene compositions prepared were stored as described above. The viscosity was measured after defined storage periods. An increase in viscosity indicates that the thiol-ene reaction has started and the composition is no longer storage stable. The sample is gelling and thus could not be used and applied. The values of the viscosity measurements are given in Tables 3, 4, 5, and 6. The viscosity is given in mPas. The measurement was carried out using the methods described above.

TABLE 3
Results of the viscosity measurements of samples
V1 and 1 to 3 at 20° C.; Viscosity in mPas

| | V1 | 1 | 2 | 3 |
|---|---|---|---|---|
| | (D + E + F) | (D + E + | (D + E + | (D + E + |
| | without | F) + | F) + | F) + |
| Measurement | stabilizer | (A + B + C) | (A + B + C) | (A + B + C) |
| Initially | 515 | 506 | 497 | 479 |
| After 1 day | | 525 | 540 | 528 |
| After 6 days | 541 | | | |
| After 8 days | | 518 | 524 | 533 |
| After 8 weeks | | 506 | 453 | 502 |
| After 3 months | | 492 | 508 | 503 |

Abbreviations:
Thiol component (D)
Component having unsaturated carbon compound (E)
Photoinitiator (F).

TABLE 4
Results of the viscosity measurements of samples
V2 to V4 at 20° C.; Viscosity in mPas

| | V2 | V3 | V4 |
|---|---|---|---|
| Measurement | (D + E + F) + A | (D + E + F) + B | (D + E + F) + C |
| Initially | 542 | 548 | 523 |
| After 1 day | 524 | 527 | 522 |
| After 10 days | 510 | 576 | 533 |
| After 20 days | 486 | 599 | 536 |
| After 11 weeks | 421 | 902 | 787 |
| After 15 weeks | 540 | 1413 | 1758 |

Abbreviations:
Free radical scavenger component (A)
Acidic component (B)
Sulfidic component (C)

TABLE 5
Results of the viscosity measurements of samples
V1 and 1 to 3 at 60° C., viscosity in mPas

| | V1 | 1 | 2 | 3 |
|---|---|---|---|---|
| | (D + E + F) | (D + E + | (D + E + | (D + E + |
| | without | F) + | F) + | F) + |
| Measurement | stabilizer | (A + B + C) | (A + B + C) | (A + B + C) |
| Initially | 515 | 506 | 497 | 479 |
| After 1 day | 1889 | 526 | 544 | 537 |
| After 6 days | 7695 | | | |
| After 8 days | | 611 | 625 | 603 |
| After 8 weeks | | 1249 | 1413 | 1381 |

TABLE 6
Results of the viscosity measurements of samples
V2 to V4 at 60° C., viscosity in mPas

| | V2 | V3 | V4 |
|---|---|---|---|
| Measurement | (D + E + F) + A | (D + E + F) + B | (D + E + F) + C |
| Initially | 542 | 548 | 523 |
| After 1 day | 538 | 1138 | 871 |
| After 10 days | 689 | 3970 | 2768 |
| After 20 days | 737 | | |
| After 11 weeks | 1589 | | |

TABLE 7
Formulations of the thiol-ene composition according
to Example 4 and Comparative Examples C5 and C6

| | V5 | V6 | 4 |
|---|---|---|---|
| Trimethylolpropane | 44.0 g | 44.0 g | 44.0 g |
| triacrylate (TMPTA) | | | |
| Pentaerythritol | 56.0 g | 56.0 g | 56.0 g |
| tetra(3-mercaptopropionate) | | | |
| 2,4,6- | 0.5 g | 0.5 g | 0.5 g |
| Trimethylbenzoylethoxyphenylphosphine | | | |
| oxide | | | |
| Pyrogallol | — | 0.05 g | 0.05 g |
| Ditridecyl thiodipropionate | — | — | 0.05 g |
| Ebercryl ® 168 | — | — | 0.05 g |

V5 Stabilizer system having components (A), (B) and (C) not added
V6 Pyrogallol as free radical scavenger component (A), components (B) and (C) not added

TABLE 8

| | V5 (20° C.) | V5 (60° C.) | | | | |
|---|---|---|---|---|---|---|
| | (D + E + F) | (D + E + F) | V6 (20° C.) | V6 (60° C.) | B4 (20° C.) | B4 (60° C.) |
| | without | without | (D + E + F) + | (D + E + F) + | (D + E + F) + | (D + E + F) + |
| Measurement | stabilizer | stabilizer | A | A | (A + B + C) | (A + B + C) |
| Initially | 461 | 461 | 300 | 300 | 301 | 301 |
| After 1 day | 925 | 10,000 | | | 319 | 311 |
| After 10 days | | | 289 | 335 | 307 | 345 |
| After 20 days | | | 327 | 439 | 296 | 376 |
| After 9 weeks | | | 288 | 678 | 294 | 410 |
| After 12 weeks | | | 297 | 885 | 294 | 681 |
| After 15 weeks | | | 270 | | 276 | |

Results of the viscosity measurements of the samples V5, V6 and B4 at 20° C. and 60° C.; Viscosity in mPas. The measurement was carried out using the methods described above.

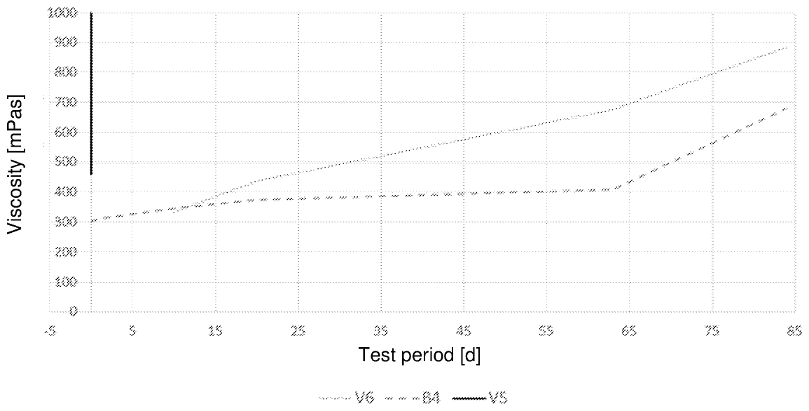

The results of the viscosity measurements from Table 8 are also shown in FIG. 1. It can be seen that without a stabilizer system, a strong increase in viscosity sets in right at the start of storage (V5). Although the increase in viscosity can be slowed down somewhat by adding a free radical scavenger component, the synergistic effect of the stabilizer system made up of free radical scavenger component (A), acidic component (B) and

sulfidic component (C) can achieve significantly increased stabilization however, without impairing the desired reactivity.

The examples show that thiol-ene compositions without a stabilizer system according to the invention have only a low level of storage stability. In particular at an elevated temperature of 60° C., without a stabilizer system according to the invention, an increase in viscosity of the composition can be measured after only 6 days (V1) or only 10 days (V3 and V4).

The invention is not limited to one of the embodiments described above, but can be modified in many ways.

All of the features and advantages resulting from the claims and the description, including structural details, spatial arrangements and method steps, can be essential to the invention both on their own and in the most varied of combinations.

1. A stabilizer system for thiol-ene and/or thiol-yne compositions, comprising the following components:
at least one free radical scavenger component,
at least one acidic component, wherein the acidic component comprises one or more organic acids, and
at least one sulfidic component selected from the group of organic sulfides.

2. The stabilizer system according to claim 1, wherein the free radical scavenger component comprises one or more free radical scavengers selected from the following group: sterically hindered phenols, sterically hindered naphthalenes and sterically hindered amines.

3. The stabilizer system according to claim 1, wherein the free radical scavenger component comprises pyrogallol, 1,3,5-tris(4-tert-butyl-3-hydroxy-2,6-dimethylbenzyl)-1,3,5-triazine-2,4,6-(1H,3H,5H)-trione, propyl gallate, or a combination thereof.

4. The stabilizer system according to claim 1, wherein one or more organic acids of the acidic component have a pKₐ in the range from 1 to 5.5 at 25° C.

5. The stabilizer system according to claim 1, wherein the acidic component comprises one or more unsaturated carboxylic acids.

6. The stabilizer system according to claim 1, wherein the sulfidic component comprises one or more organic sulfides selected from the group consisting of ditridecyl thiodipropionate, dilauryl thiodipropionate, distearyl thiodipropionate, dimethyl thiodipropionate, octadecyl 3-[[3-(dodecyloxy)-3-oxopropyl]thio]propionate, and dimyristyl thiodipropionate.

7. The stabilizer system according to claim 1, wherein the at least one free radical scavenger component and the at least one sulfidic component comprise the same substance.

8. The stabilizer system according to claim 1, wherein the free radical scavenger component is used at 10 to 80 wt % and the acidic component and the sulfidic component at 10 to 50 wt % each based on the stabilizer system.

9. A method of stabilizing a radiation-curable or thermally curable thiol-ene and/or thiol-yne composition, wherein the radiation-curable or thermally curable thiol-ene and/or thiol-yne composition comprises at least one thiol component in combination with at least one unsaturated carbon compound, comprising combining the radiation-curable or thermally curable thiol-ene and/or thiol-yne composition with the stabilizing system according to claim 1.

10. A radiation-curable thiol-ene or thiol-yne composition comprising at least one stabilizer system according to claim 1, at least one thiol component, a component having at least one unsaturated carbon compound and a photoinitiator.

11. The radiation-curable thiol-ene or thiol-yne composition according to claim 10, wherein the thiol component has one thiol or several thiols each having two or more free thiol functions.

12. The radiation-curable thiol-ene or thiol-yne composition according to claim 10, wherein the stabilizer system is contained in an amount from 0.05 to 1.5 wt %.

13. The stabilizer system according to claim 5, wherein the one or more unsaturated carboxylic acids is selected from the group consisting of methacrylic acid, acrylic acid, and derivatives thereof.

14. The stabilizer system according to claim 7, wherein at least one free radical scavenger component and the at least one sulfidic component comprise the same substance, wherein the substance is selected from the group consisting of thiodiethylene bis[3-[3,5-di-tert-butyl-4-hydroxyphenyl]propionate], 2,2′-thiobis(6-tert-butyl-p-cresol), 4,4′-thiobis(2-t-butyl-5-methylphenol), and 4,6-bis(octylthiomethyl)-o-cresol.

15. The radiation-curable thiol-ene or thiol-yne composition according to claim 12, wherein the stabilizer system is contained in an amount from 0.1 to 0.25 wt %, based on the polythiol.
